(19) United States
(12) Patent Application Publication
(10) Pub. No.: US 2015/0249913 A1
(43) Pub. Date: Sep. 3, 2015

(54) LOCATION-BASED SECURE WAVE

(71) Applicants: Rong Hua, San Carlos, CA (US); Rushik Navinbhai Upadhyay, Milpitas, CA (US); Sahib Bal, San Jose, CA (US)

(72) Inventors: Rong Hua, San Carlos, CA (US); Rushik Navinbhai Upadhyay, Milpitas, CA (US); Sahib Bal, San Jose, CA (US)

(21) Appl. No.: 14/194,595

(22) Filed: Feb. 28, 2014

(51) Int. Cl. H04W 8/00; H04W 64/00; H04W 76/02

(52) U.S. Cl. CPC H04W 8/005; H04W 76/023; H04W 64/00

(57) ABSTRACT

Methods and systems for pairing communication instruments are described. To initiate pairing, at least one user waves a device at a location. Based on the location, a service provider determines and provides the user who waved the device a list of other communication instruments in the area that the user may want to be paired with. For example, the service provider determines if any other communication instruments at the location was waved at about the same time, if a static device (e.g., merchant point of sale device) is present at the location, if a physical advertisement with a message to be communicated (e.g., a billboard with a QR code) is present at the location, or if any device that the user has been paired with previously is present at the location. The devices may be automatically paired or mutual confirmation may be required before the communication instruments are connected. Pairing can take place between two or more consumers or consumers and merchants.

### BACKGROUND

1. Field of the Invention

The present invention generally relates to pairing devices to complete transactions or share information, and more specifically to pairing devices using a waving gesture.

2. Related Art

The use of mobile phones to share information is widespread. In particular, mobile devices are often paired to share data, such as personal photos, contacts, play lists, passwords or friendship information for social networking. Usually, such data sharing requires security protection.

Exchanging information stored in mobile phones when two such devices meet is often tedious. Consider sending an email or short message service (SMS) message from one phone to another. First one must ask the owner of the other device for an address; then a message has to be composed and sent. There is too much to do in this process.

There have been various attempts to connect and pair mobile devices in order to share information between the devices. One example is the Bump application, which detects device location and accelerometer action to allow two smartphone users to bump their phones together to share information between the phones. In the Bump application, Global Positioning System (GPS) components detect the proximity of the two devices to one another, and accelerometers within the devices detect the movement or “bump” action of the devices touching one another, to initiate the communication link between the bumped devices. The Bump application, however, requires that the two devices physically touch or at least are in very close proximity to each other, and that the same movement or gesture be made by the two users at the same time. This can be problematic when one of the devices is not movable and/or unmanned. Moreover, this particular technique does not easily scale upward when more than two devices are involved.

Thus, a need exists for a simpler, more secure, and faster way to pair devices.

### BRIEF DESCRIPTION OF THE FIGURES

FIG. 1 is a block diagram illustrating a system for pairing electronic devices according to an embodiment of the present disclosure;

FIG. 2 is a flowchart showing a method for pairing electronic devices according to an embodiment of the present disclosure; and

FIG. 3 is a block diagram of a system for implementing one or more components in FIG. 1 according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The systems and methods described herein provide secure and location-based device pairing via a waving gesture. As used herein “pairing” refers to the communicative coupling of two or more communication instruments, such as electronic devices and physical or print advertisements, to enable the sharing and transfer of data. Electronic devices include various computing devices such as smartphones. Physical or print advertisements include billboards, signs, and posters. For example, pairing can be used for mobile payments, social networking, and/or advertising.

The present disclosure describes techniques that identify other communication instruments that are candidates for pairing by matching the location of the communication instruments. There are many situations where two or more individuals in the same location or venue wish to establish a pairing. For example, a user at a merchant location may wish to pair with a merchant device to make a payment. Friends may want to make payments to each other after a meal at a restaurant. A merchant may want to connect with a consumer to pass information on special deals or discounts. Pairing can take place between two or more consumers or consumers and merchants. There are also situations where one or more devices wish to pair with one or more other devices or physical objects, such as a merchant point of sale (POS) terminal or an advertisement (e.g., a poster or billboard).

To initiate pairing, at least one user waves a device at a location. Based on the location, a service provider determines and provides the user who waved the device a list of other communication instruments in the area that the user may want to be paired with. For example, the service provider determines if any other device at the location was waved at about the same time, if a static device (e.g., merchant point of sale device) is present at the location, if a physical advertisement with a message to be communicated (e.g., a billboard) is present at the location, or if any device that the user has been paired with previously is present at the location. The communication instruments may be automatically paired or mutual confirmation may be required before the instruments are connected.

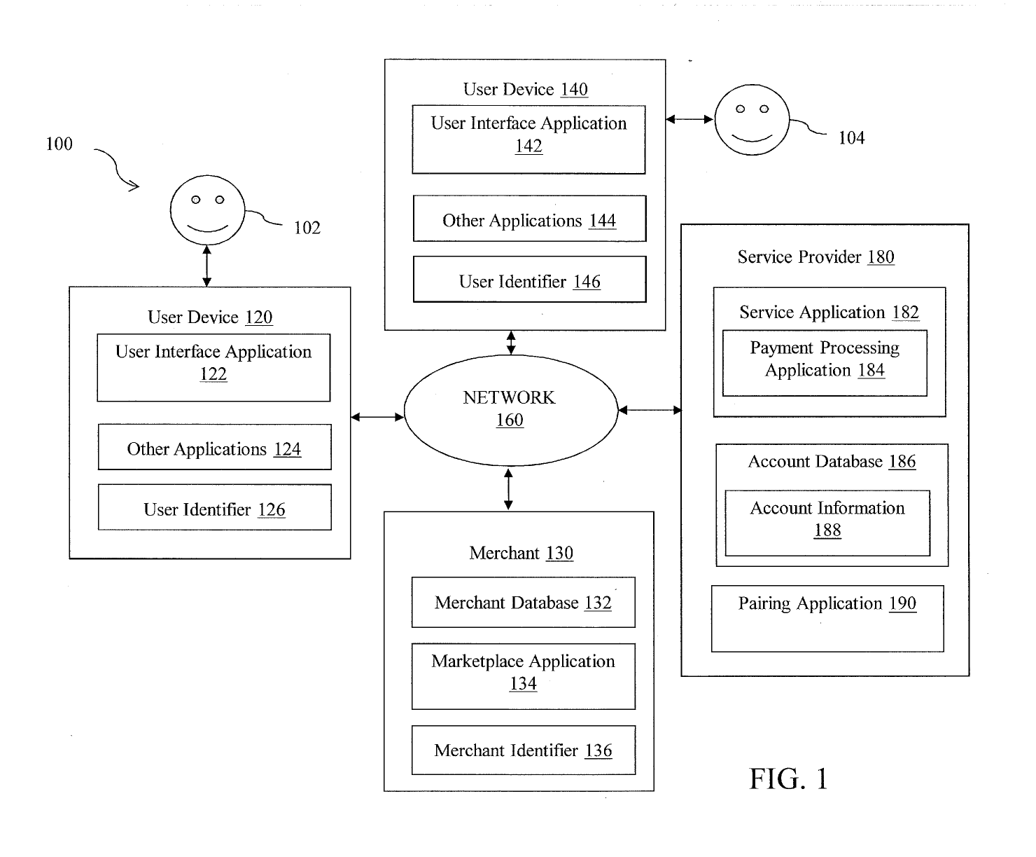

FIG. 1 shows one embodiment of a block diagram of a network-based system 100 adapted to pair communication instruments, such as user devices 120 and 140 over a network 160. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a first user device 120 (e.g., a smartphone), one or more merchant servers or devices 130 (e.g., network server devices), a second user device 140 (e.g., a smartphone) and at least one service provider server or device 180 (e.g., network server device) in communication over the network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet. As such, in various embodiments, the user devices 120 and 140, merchant servers or devices 130, and service provider server or device 180 may be associated with a particular link (e.g., a link, such as a URL (Uniform Resource Locator) to an IP (Internet Protocol) address).

The first user device 120 and second user device 140, in one embodiment, may be utilized by first user 102 and second user 104 to interact with the service provider server 180 over the network 160. For example, users 102 and 104 may conduct financial transactions (e.g., account transfers) with the service provider server 180 and with each other via the user devices 120 and 140.

The first user device 120 and second user device 140, in various embodiments, may be implemented using any appropriate combination of hardware and/or software configured for wired and/or wireless communication over the network 160. The first user device 120, in one embodiment, may be utilized by the first user 102 to interact with the service provider server 180 over the network 160. The second user device 140, in turn, may be used by the second user 104 to interact with the service provider server 180. For example, the first user 102 may conduct financial transactions (e.g., account transfers) with the service provider server 180 via the user device 120. In various implementations, the user device 120 may include at least one of a wireless cellular phone, personal digital assistant (PDA), satellite phone, mobile device, etc.

The first user device 120, in one embodiment, includes a user interface application 122, which may be utilized by the first user 102 to conduct transactions (e.g., shopping, purchasing, bidding, payment, etc.) with the second user device 140, merchant server or device 130 or with the service provider server 180 over the network 160. In one aspect, purchase expenses may be directly and/or automatically debited from an account related to the first user 102 via the user interface application 122.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160.

In an example, the first user 102 is able to access merchant websites via the one or more merchant servers 130 to view and select items for purchase, and the first user 102 is able to purchase items from the one or more merchant servers 130 via the service provider server 180. Accordingly, in one or more embodiments, the first user 102 may conduct transactions (e.g., purchase and provide payment for one or more items) from the one or more merchant servers 130 via the service provider server 180.

The first user device 120, in various embodiments, may include other applications 124 as may be desired in one or more embodiments of the present disclosure to provide additional features available to the first user 102. In one example, such other applications 124 may include security applications for implementing client-side security features, programmatic client applications for interfacing with appropriate application programming interfaces (APIs) over the network 160, and/or various other types of generally known programs and/or software applications. In still other examples, the other applications 124 may interface with the user interface application 122 for improved efficiency and convenience.

In various implementations, a user profile may be created using data and information obtained from cell phone activity over the network 160. Cell phone activity transactions may be used by the service provider server 180 to create at least one user profile for the first user 102 based on activity from the first user device 120 (e.g., cell phone), and for the second user 104 based on activity from the second user device 140. The user profile may be updated with each financial and/or information transaction (e.g., payment transaction, purchase transaction, etc.) achieved through use of the user devices 120 and 140. In various aspects, this may include the type of transaction and/or the location information from the user devices 120 and 140. As such, the profile may be used for recognizing patterns of potential fraud, setting transaction limits on the user, etc.

The first user device 120, in one embodiment, may include at least one user identifier 126, which may be implemented, for example, as operating system registry entries, cookies associated with the user interface application 122, identifiers associated with hardware of the first user device 120, or various other appropriate identifiers. The user identifier 126 may include one or more attributes related to the first user 102, such as personal information related to the first user 102 (e.g., one or more user names, passwords, photograph images, biometric IDs, addresses, phone numbers, social security number, etc.) and banking information and/or funding sources (e.g., one or more banking institutions, credit card issuers, user account numbers, security data and information, etc.). In various implementations, the user identifier 126 may be passed with a user login request to the service provider server 180 via the network 160, and the user identifier 126 may be used by the service provider server 180 to associate the first user 102 with a particular user account maintained by the service provider server 180.

Second user device 140 may have similar applications and modules as first user device 120. Second user device 140 may also include a user interface application 142 and one or more other applications 144 which may be used, for example, to provide a convenient interface to permit second user 104 to browse information and view assigned tasks over network 160. For example, in one embodiment, user interface application 142 may be implemented as a web browser configured to view information available over the Internet and communicate with service provider server 180.

Second user device 140 may further include other applications 144 such as security applications for implementing client-side security features, programmatic client applications for interfacing with appropriate application programming interfaces (APIs) over network 160, or other types of applications. Applications 144 may also include email, text, IM, and voice applications that allow second user 104 to communicate through network 160, receive messages from first user 102, and create and manage funding sources. Second user device 140 includes one or more user identifiers 146 which may be implemented, for example, as operating system registry entries, cookies associated with user interface application 142, identifiers associated with hardware of second user device 140, or other appropriate identifiers, such as used for payment/recipient/device authentication, e.g., the phone number associated with second user device 140. Identifiers may be used by a service provider to associate second user 104 with a particular account maintained by the service provider.

First user device 120 and second user device 140, in one embodiment, each include a geo-location component adapted to monitor and provide an instant geographical location (i.e., geo-location) of the user devices 120 and 140. In one implementation, the geo-location of the user devices 120, 140 may include global positioning system (GPS) coordinates, zip-code information, area-code information, street address information, and/or various other generally known types of geo-location information. In one example, the geo-location information may be directly entered into the user devices 120, 140 by a user via a user input component, such as a keyboard, touch display, and/or voice recognition microphone. In another example, the geo-location information may be automatically obtained and/or provided by the user devices 120, 140 via an internal or external GPS monitoring component. In other embodiments, the geo-location can be automatically obtained without the use of GPS. In some instances, cell signals or wireless signals are used. This helps to save battery life and to allow for better indoor location where GPS typically does not work.

In one aspect, when interfacing with the user devices 120, 140, the users 102, 104 may elect to provide or may be prompted to provide permission for the release of geo-location information. Accordingly, the users 102, 104 may have exclusive authority to allow transmission of geo-location information from the user devices 120, 140 to the service provider server 180. In any instance, the service provider server 180 may communicate with the user devices 120, 140 via the network 160 and request permission to acquire geo-location information from the users device 120, 140 for geo-location based mobile commerce.

User devices 120, 140 may each include one or more of a motion sensor, an image sensor (e.g., camera), a voice sensor (e.g., microphone), an optical sensor, and any other kind of device suitable to collect information from a user. Motion sensors such as motion detectors, accelerometers and/or gyroscopes may monitor speed, acceleration, position, rotation, and other characteristics of body and appendage motion. The motion sensor captures movement of a user, such as a pose, position, or gesture. Example gestures include for instance, an “air quote” gesture, a bowing gesture, a curtsey, a cheek-kiss, a finger or hand motion, a head bobble or movement, a high-five, a nod, a raised fist, a salute, a swiping or wave motion, a thumbs-up motion, a hand-moving-in-circle or hand waving gesture, or a finger pointing gesture. An image sensor captures images of the user and other objects. A voice sensor captures the voice or sounds made by the user. An optical sensor captures and characterizes light. Information captured by the sensors may be collected, stored, and associated with a specific user.

The one or more merchant servers 130, in various embodiments, may be maintained by one or more business entities (or in some cases, by a partner of a business entity that processes transactions on behalf of business entities). Examples of businesses entities include merchant sites, resource information sites, utility sites, real estate management sites, social networking sites, etc., which offer various items for purchase and payment. In some embodiments, business entities may need registration of the user identity information as part of offering the items to the user 102 over the network 160. As such, each of the one or more merchant servers 130 may include a merchant database 132 for identifying available items, which may be made available to the user devices 120, 140 for viewing and purchase by the users 102, 104. In one or more embodiments, users 102, 104 may complete a transaction such as purchasing the items via service provider server 180.

Each of the merchant servers 130, in one embodiment, may include a marketplace application 134, which may be configured to provide information over the network 160 to the user interface application 122, 142 of the user devices 120, 140. For example, first user 102 may interact with the marketplace application 134 through the user interface application 122 over the network 160 to search and view various items available for purchase in the merchant database 132.

Each of the merchant servers 130, in one embodiment, may include at least one merchant identifier 136, which may be included as part of the one or more items made available for purchase so that, e.g., particular items are associated with particular merchants. In one implementation, the merchant identifier 136 may include one or more attributes and/or parameters related to the merchant, such as business and banking information. The merchant identifier 130 may include attributes related to the merchant server or device 130, such as identification information (e.g., a serial number, a location address, GPS coordinates, a network identification number, etc.). In various embodiments, user 102 may conduct transactions (e.g., searching, selection, monitoring, purchasing, and/or providing payment for items) with each merchant server 130 via the service provider server 180 over the network 160.

A merchant website may also communicate (for example, using merchant server 130) with the service provider through service provider server 180 over network 160. For example, the merchant website may communicate with the service provider in the course of various services offered by the service provider to merchant website, such as payment intermediary between customers of the merchant website and the merchant website itself. For example, the merchant website may use an application programming interface (API) that allows it to offer sale of goods in which customers are allowed to make payment through the service provider, while users 102, 104 may have an account with the service provider that allows users 102, 104 to use the service provider for making payments to merchants that allow use of authentication, authorization, and payment services of service provider as a payment intermediary. The merchant website may also have an account with the service provider.

The service provider server 180, in one embodiment, may be maintained by a transaction processing entity or an online service provider, which may provide processing for financial transactions and/or information transactions between the first user 102, the second user 104, and one or more of the merchant servers 130. As such, the service provider server 180 includes a service application 182, which may be adapted to interact with the user device 120, 140 and/or each merchant server 130 over the network 160 to facilitate the searching, selection, purchase, and/or payment of items by the users 102, 104 from one or more of the merchant servers 130. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service application 182, in one embodiment, utilizes a payment processing application 184 to process purchases and/or payments for financial transactions between the users 102, 104 and each of the merchant servers 130. In one implementation, the payment processing application 184 assists with resolving financial transactions through validation, delivery, and settlement. As such, the service application 182 in conjunction with the payment processing module 184 settles indebtedness between the users 102, 104 and each of the merchants 130, wherein accounts may be directly and/or automatically debited and/or credited of monetary funds in a manner as accepted by the banking industry.

The service provider server 180, in one embodiment, may be configured to maintain one or more user accounts and merchant accounts in an account database 186, each of which may include account information 188 associated with one or more individual users (e.g., first user 102 and second user 104) and merchants (e.g., one or more merchants associated with merchant servers 130). For example, account information 188 may include private financial information of users 102, 104 and each merchant associated with the one or more merchant servers 130, such as one or more account numbers, passwords, credit card information, banking information, or other types of financial information, which may be used to facilitate financial transactions between first user 102, second user 104, and the one or more merchants associated with the merchant servers 130. Merchant information may also include locations of merchant advertisements, such as billboard, posters, or signs that are associated with information communication or processing, as well as data associated with the advertisements. In various aspects, the methods and systems described herein may be modified to accommodate users and/or merchants that may or may not be associated with at least one existing user account and/or merchant account, respectively.

In one implementation, the users 102, 104 may have identity attributes stored with the service provider server 180, and users 102, 104 may have credentials to authenticate or verify identity with the service provider server 180. User attributes may include personal information, banking information and/or funding sources. In various aspects, the user attributes may be passed to the service provider server 180 as part of a login, search, selection, purchase, and/or payment request, and the user attributes may be utilized by the service provider server 180 to associate users 102, 104 with one or more particular user accounts maintained by the service provider server 180.

In various embodiments, the service provider server 180 also includes a pairing application 190 that pairs communication instruments based on their location. The pairing application 190 receives or determines the location of communication instruments, determines possible pairing activity at the location, displays possible pairing activity, and then pairs communication instruments. Pairing between instruments can be automatic or require manual confirmation among users.

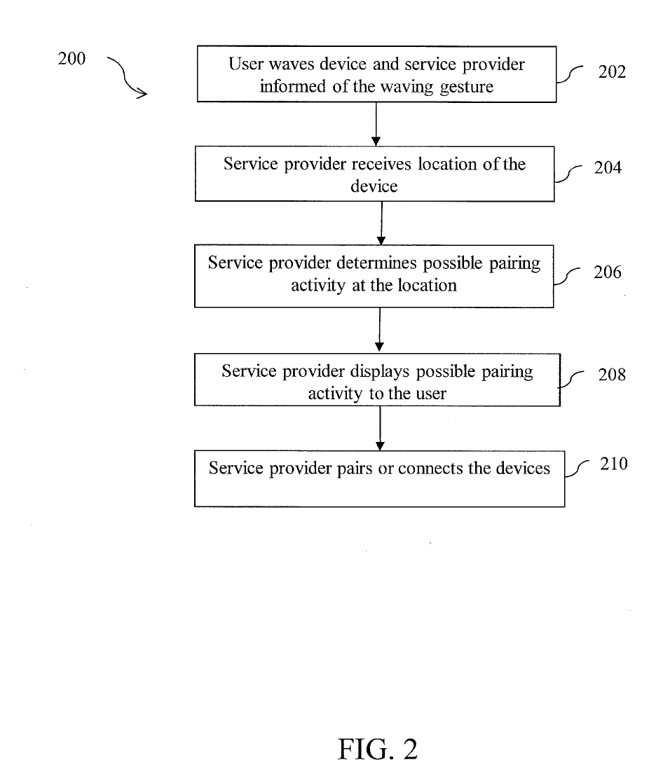

Referring now to FIG. 2, a flowchart of a method 200 for pairing communication instruments is illustrated according to an embodiment of the present disclosure. In various embodiments, the users 102, 104 each register with a service provider, which runs a mobile application. Registration may include signing up for the service and agreeing to any terms required by the service provider, such as through a user device. In one embodiment, the user device is a mobile computing device, such as a smart phone, a PC, or a computing tablet. In other embodiments, registration may be done completely through the user device, partially through the user device, or without using the user device, such as through a phone call or in-person visit to a representative of the payment service provider.

The user may be requested to provider specific information for registration, such as, but not limited to, a name, address, phone number, email address, picture, a user name for the account, and a password or PIN for the account. The type of information may depend on whether the user already has an account with the service provider. Requested information may be entered through the user device or other means, including voice or manual key entry. Once all the requested information is received and confirmed, the service provider may create an account for the user.

At step 202, the first user 102 waves the first user device 120 and the service provider server 180 is informed of or receives information regarding the waving gesture of the user device 120. As used herein, a “wave” or “waving gesture” means a movement that includes a back and forth motion. For example, the first user 102 may move the first user device 120 back and forth from left to right (or right to left), and/or from top to bottom (or bottom to top). The waving gesture is detected by a motion sensor in the first user device 120, such as an accelerometer. The accelerometer alerts the service provider server 180 when the accelerometer detects movement. The accelerometer can be used to recognize specific gestures and body movements.

The accelerometer has a sensing element that detects acceleration from motion and/or gravity. The sensor generates and outputs an electrical signal representative of the detected acceleration. Changes in movement of the first user device 120 result in changes in acceleration, which produces corresponding changes in the electrical signal output of the sensor.

At step 204, the service provider server 180 receives the location of the first user device 120. The waving gesture triggers the GPS or geo-location component of the first user device 120 to obtain the exact location of the first user device 120. The geo-location and device ID of the first user device 120 are then sent to the service provider server 180.

At step 206, the service provider server 180 determines possible pairing activity at the location. In one embodiment, the service provider determines whether another user or users (e.g., second user 104) waved their user device at the same location or proximate to the location of the first user device 120. The other users need not have waved the user device at the same time, but in some embodiments, the other users waved the device within a predetermined time interval (e.g., within about 5-10 seconds) after or before the first user 102 performed the waving gesture. The service provider may be notified of common accelerations or movements between devices as a characteristic to uniquely identify possible pairing activity, e.g., based on simultaneous gyroscopic measurements inside user devices.

In some embodiments, the service provider investigates the other users (e.g., second user 104) present at the location to determine if they have a relationship with the first user 102, regardless of whether they waved their user device or not. For instance, the server 180 may determine whether or not the first user 102 has dealt with or had contact with the second user 104 before. For example, the service provider can find out if the first user 102 had previously paid user 104 (or vice versa), and/or if any type of funds transfer has ever occurred between the users.

If the service provider discovers a previous relationship, the server 180 can examine how many times and in what context those contacts were made. After a certain number of times (which may be predetermined or set by the users 102, 104), the server 180 may automatically connect first user 102 and second user 104.

In some embodiments, the service provider server 180 may require that devices first establish a “trust relationship” before they are allowed to connect to one another. This trust relationship may be established if the devices were previously paired and connected to each other. In one embodiment, this previous pairing enables the devices to communicate with each other in the future without further authentication. Pairing information relating to current and previously established pairings may be stored in a database. This pairing information may include names, addresses, phone numbers, and other contact information of the users.

The service provider may also determine whether or not the first user 102 and the second user 104 are connected by a social network such as Facebook, Twitter, Instagram, Pinterest, Flickr, etc. If the users are not directly connected, the service provider can determine how far they are separated from each other. For example, if the first user 102 and the second user 104 have a friend in common, it is more likely that they would like to be paired, rather than if they were separated by 2-3 friends. The service provider may also analyze the type and/or amount of communication between the two users 102, 104. For example, the server 180 may determine that the two users are closely related in the social network if the two users often exchange messages and/or posts on a social network website.

In other embodiments, the service provider server 180 can access a list of locations visited by the first and second user devices 120 and 140 over a given time period. It is expected that users who visited the same location over a given time period are more likely to know each other and more likely to want to be paired.

The service provider server 180 may also determine whether there are any devices having a static location that correspond to the same geo-location or that are proximate to the geo-location of the first user device 120. A merchant device (e.g., merchant server 130), such as a Point of Sale (POS) device, may have a registered geo-location that is a static location. For example, the location of the first user device 120 may be compared to the location of the merchant device 130 to determine if they are sufficiently close to one another (e.g., within a predetermined small range of one another).

The service provider may also analyze historic geo-location information of the first user device 120 to determine whether the first user 102 frequents a particular merchant that is associated with the merchant device 130. For example, the first user 102 may buy coffee and donuts from Dunkin′ Donuts every week or every day, and it is therefore likely that the user 102 is interested in connecting to the merchant device 130 at Dunkin′ Donuts. The server 180 can also analyze whether any financial transactions between the merchant device 130 and user 102 have occurred in the past and how often they occurred. Specifically, the server 180 can determine whether the merchant device 130 and the first user device 120 have been paired or connected before.

In addition, the service provider server 180 can evaluate the first user 102's social networks to determine if the user 102 is connected to the merchant. For example, the service provider can determine if the user 102 is a “Fan” of the merchant, if the user 102 “liked” the merchant, if the user 102 is following the merchant, etc.

Other devices that may have a static location include beacons, electronic billboards, and other devices that are used for advertisements. The service provider server 180 can determine whether the first user 102 wants to be paired with a beacon or billboard based on the methods discussed above with respect to the merchant device 130 and other uses (e.g., second user 104). Beacons may be set up by merchants or individuals offering various items, such as products and/or services for sale. A beacon is a short range communication device having a known or fixed location that provides a signal that can be detected by mobile devices within a certain proximity of the beacon. An example of a beacon is a radio frequency (RF) beacon (e.g., Bluetooth™ low energy (BLE) beacon), infrared beacon or a radio frequency identifier (RFID) tag. When the first user 102 comes within range of a beacon, the first user device 120 is able to connect to and receive messages from the beacon.

Electronic or digital billboards advertise products and services, typically with changing images and/or interactive messages. For example, a billboard may contain a Quick Response (QR) code embedded with additional content on a product or service and/or with discounts and promotions. If the service provider server 180 determines that the first user 102 wants to pair with the billboard, the information in the QR code is sent to the first user device 120, without the first user device 120 scanning or reading the QR code. The user 102 does not need to bother with framing or capturing the code on the user device 120.

In another embodiment, the service provider determines what physical advertisements are present at the location of the user device 120. The service provider server 180 knows where these physical advertisements are located because of information received from merchants or other advertisers. Based on the location of the user device 120 and this information, the server 180 can determine what physical or print advertisement the user 102 wants to be paired with. In one example, the service provider server 180 determines that the user 102 wants to be paired with a billboard or poster because the poster is associated with a merchant that the user 102 has dealt with in the past or that the poster is the only communication instrument in proximity to the user. If multiple communication instruments are detected in proximity to the user 102, the user 102 may be presented with a list of the instruments from which to choose from. Upon selection, information associated with the selected communication instrument is displayed to the user 102 on the user device 120. For example, information such as a website, contact information, and other details may be displayed.

In one embodiment, the physical advertisement includes a QR code. Instead of the user 105 walking up to a billboard or poster and scanning the QR code, the user 105 receives the information in the QR code by waving the user device 120. Again, the user 102 does not need to bother framing or capturing the code on the user device 120, and information embedded in or associated with the QR code can be displayed on the user device 120, such as a website with information than enables the user to purchase a product shown on the physical advertisement.

Once the service provider collects and organizes all the possible communication instruments the first user 102 may want to connect with, the service provider creates a list of users/merchants (e.g., second user 104, merchant device 130, beacon, billboard, poster, sign, etc.) with whom the first user 102 is likely to want to pair with. In various embodiments, the service provider ranks the users/merchants in order of most likely to least likely to be paired with the first user 102. In another embodiment, communication instruments for possible pairing are ones within visual distance of the user 102, e.g., only communication instruments that the user 102 can practically see are identified. For example, depending on the size of the communication instrument, the distance may vary, as larger instruments, such as a billboard will have a larger distance than a merchant POS device or small poster advertisement. Visual distances can be based on average or typical distances assuming a user with 20/20 vision in a clear environment.

At step 208, the service provider displays the possible pairing activity to the first user 102 and allows the first user 102 to select communication instruments from the list. In various embodiments, the possible pairing activity is also displayed to the other users (e.g., second user 104) in the same location and these other users are allowed to select which communication instruments they want to pair with. In this way, the pairing between instruments is controlled by the users and requires mutual acknowledgment of all parties involved before devices are connected. Once the users approve the pairing, information can be sent to the server 180 so that the information can be distributed and shared between the identified users.

Once the server 180 receives the first user 102's selection, at step 210, the service provider pairs or connects the identified communication instruments. More than two instruments, for example, three, four, five, or more, can be paired. Once the instruments are connected, they can be used for mobile payment, advertisements, and for sharing information in social networks. As discussed above, in some embodiments, there is automatic pairing based on the history between the users, or the user and the merchant.

Advantageously, the present disclosure provides pairing that is location-based, seamless, and secure. The methods are seamless because login to a user account is not necessary. The pairing is secure because the methods only connect instruments that are in the same location. In addition, the methods and systems analyze historic geo-location information, the identities of the users (e.g., using device ID), historic interactions between the users, and/or require manual confirmations. Risk models validate and confirm the identities of the sender and recipient of information to minimize fraud. Moreover, the instrument pairing uses basic sensors installed on every smartphone in use today, and does not require specialized hardware.

### EXAMPLES

Exemplary methods of pairing between two or more users, or users and merchants will now be described.

Sharon walks into a Starbucks shop and waves her smartphone to pair with a Starbucks POS device. It is determined that Sharon has been at this Starbucks several times and has even made payments to this POS device in the past. Sharon orders a grand soy latte, the clerk at the counter enters $3.88 on the POS device, and Sharon confirms the payment on her smartphone.

Sharon, Robert, and Sam sit down at a restaurant and wave their devices at the same time. The three devices are paired with each other because they are waved at the same location at the same time. The three devices are also paired to the POS device of the restaurant based on the location. Sharon, Robert, and Sam decide that they want to split the restaurant bill. Sharon sets up a group that includes her, Robert and Sam, and confirms the group with the restaurant on her device. After their meal, the restaurant sends the total amount of the bill to Sharon, and the split payment amounts to Robert and Sam. Sharon pays the total bill to the restaurant using her device, and confirms the group′payment with the restaurant. She also receives the split payment amounts from Robert and Sam.

Sharon and Robert meet at the mall. They wave each of their devices to pair the devices. Sharon remember that she owes Robert $10, and she opens up the mobile application. She finds Robert on her list and enters $10 as the amount to be sent. Robert receives the $10 immediately.

Sharon walks into a music store, and sees a poster for a Bruno Mars concert. A QR code on the poster provides more information about purchasing tickets for the concert. She had previously purchased tickets for another Bruno Mars concert. Sharon waves her smartphone, and she is paired with the poster. The information on the poster is presented to Sharon on her smartphone. She clicks on a link, is taken to a ticketing website and purchases a ticket to the concert.

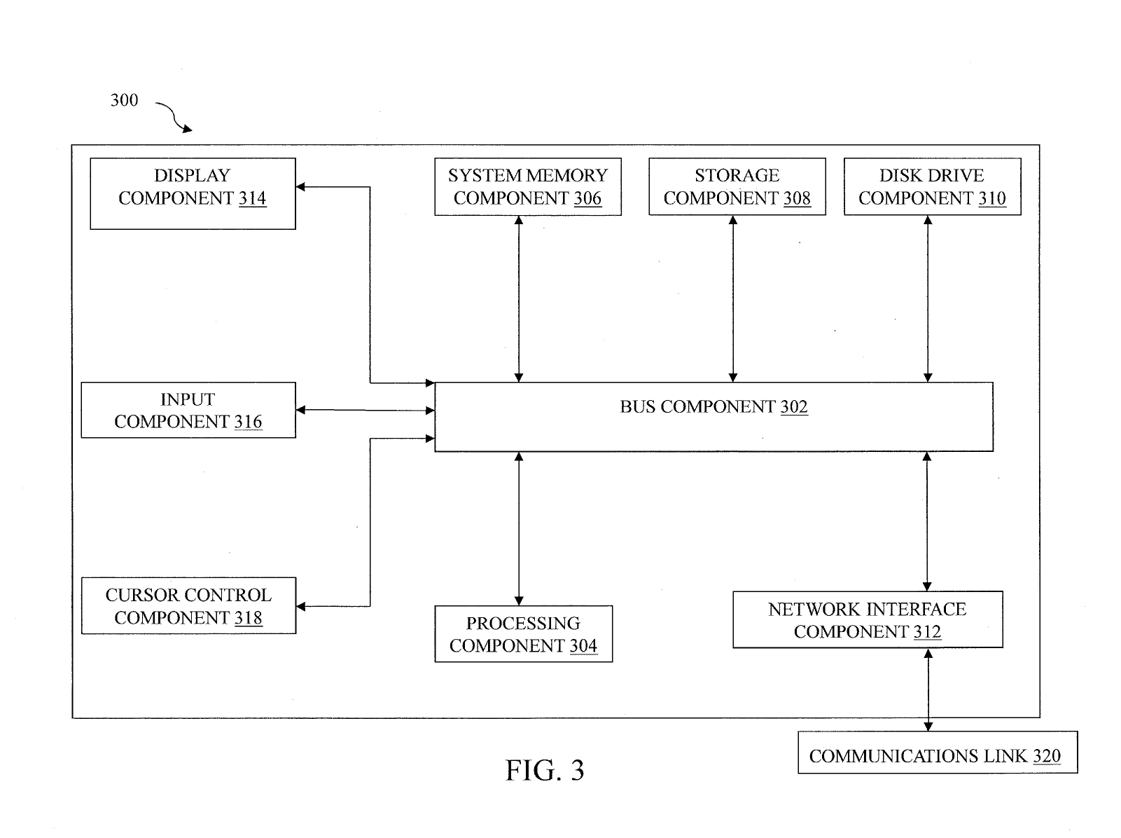

Referring now to FIG. 3, a block diagram of a system 300 is illustrated suitable for implementing embodiments of the present disclosure, including user devices 120 and 140, one or more merchant servers or devices 130, and service provider server or device 180. System 300, such as part of a cell phone, a tablet, a personal computer and/or a network server, includes a bus 302 or other communication mechanism for communicating information, which interconnects subsystems and components, including one or more of a processing component 304 (e.g., processor, micro-controller, digital signal processor (DSP), etc.), a system memory component 306 (e.g., RAM), a static storage component 308 (e.g., ROM), a network interface component 312, a display component 314 (or alternatively, an interface to an external display), an input component 316 (e.g., keypad or keyboard), and a cursor control component 318 (e.g., a mouse pad).

In accordance with embodiments of the present disclosure, system 300 performs specific operations by processor 304 executing one or more sequences of one or more instructions contained in system memory component 306. Such instructions may be read into system memory component 306 from another computer readable medium, such as static storage component 308. These may include instructions to process financial transactions, make payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 304 for execution. Such a medium may take many forms, including but not limited to, non-volatile media, volatile media, and transmission media. In various implementations, volatile media includes dynamic memory, such as system memory component 306, and transmission media includes coaxial cables, copper wire, and fiber optics, including wires that comprise bus 302. Memory may be used to store visual representations of the different options for searching, auto-synchronizing, making payments or conducting financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 300. In various other embodiments, a plurality of systems 300 coupled by communication link 320 (e.g., network 160 of FIG. 1, LAN, WLAN, PTSN, or various other wired or wireless networks) may perform instruction sequences to practice the disclosure in coordination with one another. Computer system 300 may transmit and receive messages, data, information and instructions, including one or more programs (i.e., application code) through communication link 320 and communication interface 312. Received program code may be executed by processor 304 as received and/or stored in disk drive component 310 or some other non-volatile storage component for execution.

In view of the present disclosure, it will be appreciated that various methods and systems have been described according to one or more embodiments for pairing electronic devices.

Although various components and steps have been described herein as being associated with user devices 120 and 140, merchant server 130, and service provider server 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a memory device storing communication instrument information; and
one or more processors in communication with the memory device and operable to:
receive information that a user waved a user device;
receive a location of the user device;
identify one or more other communication instruments at the location that are candidates for pairing; and
display information associated with at least one of the candidates on the user device.

2. The system of claim 1, wherein the other communication instruments comprise another user device, a merchant device, a physical advertisement, or any combination thereof.

3. The system of claim 1, wherein identifying other communication instruments comprises analyzing the other communication instruments present at the location of the user device.

4. The system of claim 3, wherein analyzing the other communication instruments comprises considering historic geo-location information of the other communication instruments, identities of other users associated with the other communication instruments, historic interactions between the user device and the other communication instruments, whether the other communication instruments were waved, or any combination thereof.

5. The system of claim 4, wherein considering historic interactions between the user device and the other communication instruments comprises determining whether the user device was previously paired with the other communication instruments.

6. The system of claim 1, wherein the one or more processors is further operable to pair the user device to one or more other communication instruments.

7. The system of claim 1, wherein the one or more processors is further operable to display the candidates to the user.

8. The system of claim 1, wherein the information is associated with a QR code on the one or more other communication instruments.

9. A method for pairing communication instruments, comprising:
receiving, by one or more hardware processors of a service provider, information that a user waved a user device;
receiving, by the one or more hardware processors, a location of the user device;
identifying, by the one or more hardware processors, one or more other communication instruments at the location that are candidates for pairing; and
displaying, by the one or more hardware processors, information associated with at least one of the candidates on the user device.

10. The method of claim 9, wherein the other communication instruments comprise another user device, a merchant device, a physical advertisement, or any combination thereof.

11. The method of claim 9, wherein identifying other communication instruments comprises analyzing the other communication instruments present at the location of the user device.

12. The method of claim 11, wherein analyzing the other communication instruments comprises considering historic geo-location information of the other communication instruments, identities of other users associated with the other communication instruments, historic interactions between the user device and the other communication instruments, whether the other communication instruments were waved, or a combination thereof.

13. The method of claim 12, wherein considering historic interactions between the user device and the other communication instruments comprises determining whether the user device was previously paired with the other devices.

14. The method of claim 9, further comprising displaying the candidates to the user.

15. The method of claim 9, wherein the information is associated with a QR code on the one or more other communication instruments.

16. A non-transitory machine-readable medium comprising a plurality of machine-readable instructions which, when executed by one or more processors, are adapted to cause the one or more processors to perform a method comprising:
receiving information that a user waved a user device;
receiving a location of the user device;
identifying one or more other communication instruments at the location that are candidates for pairing; and
displaying information associated with at least one of the candidates on the user device.

17. The non-transitory machine-readable medium of claim 16, wherein the other communication instruments comprise another user device, a merchant device, a physical advertisement, or any combination thereof.

18. The non-transitory machine-readable medium of claim 16, wherein identifying other communication instruments comprises considering historic geo-location information of the other communication instruments, identities of other users associated with the other communication instruments, historic interactions between the user device and the other communication instruments, whether the other communication instruments were waved, or a combination thereof.

19. The non-transitory machine-readable medium of claim 16, wherein the method further comprises displaying the candidates to the user.

20. The non-transitory machine-readable medium of claim 16, wherein the information is associated with a QR code on the one or more other communication instruments.
